(19) United States
(12) Patent Application Publication
(10) Pub. No.: US 2026/0155897 A1
(43) Pub. Date: Jun. 4, 2026

(54) ADAPTIVE CHANNEL MODEL TESTING SYSTEM FOR SATELLITE COMMUNICATIONS

(71) Applicant: KEYSIGHT TECHNOLOGIES, INC., SANTA ROSA, CA (US)

(72) Inventor: Maxim Pletner, SANTA CLARA, CA (US)

(21) Appl. No.: 19/393,167

(22) Filed: Nov. 18, 2025

Related U.S. Application Data
(60) Provisional application No. 63/726,428, filed on Nov. 29, 2024.

(51) Int. Cl. H04B 17/00; H04B 17/11; H04B 17/21; H04B 17/391

(52) U.S. Cl. CPC H04B 17/0087; H04B 17/11; H04B 17/21; H04B 17/3912

(57) ABSTRACT

A system for adaptive channel model testing in satellite communications includes a channel emulator configured to simulate channel conditions, multiple receivers configured to process signals from the channel emulator, result extractor modules configured to collect performance data from the receivers, a model refinement module configured to analyze the performance data and identify adjustments for channel models, and a channel modification module configured to update the channel emulator settings based on the identified adjustments, thereby forming a feedback loop for continuous adaptation of channel models.

### CROSS-REFERENCE TO RELATED APPLICATION

The present application claims priority under 35 U.S.C. § 119(e) to U.S. Provisional Application No. 63/726,428 filed on Nov. 29, 2024. The entire disclosure of U.S. Provisional Application No. 63/726,428 is specifically incorporated herein by reference in its entirety.

### FIELD

The present disclosure relates to adaptive channel modeling for satellite communication testing, and more particularly to a system and method for real-time channel model adaptation based on receiver feedback and performance metrics.

### BACKGROUND

Satellite communication systems play a crucial role in modern telecommunications, enabling global connectivity and data transmission across vast distances. These systems rely on complex channel models to simulate and predict the behavior of signals as they travel through the atmosphere and space. Accurate channel modeling is essential for designing robust communication systems, optimizing performance, and ensuring reliable service delivery.

Traditional approaches to channel modeling in satellite communications often involve static models that may not adequately capture the dynamic nature of real-world conditions. These models typically use predetermined parameters and assumptions about signal propagation, which can lead to discrepancies between simulated and actual performance. As a result, testing and validation of satellite communication systems may not fully represent the challenges faced in operational environments.

The increasing complexity of satellite networks, coupled with the demand for higher data rates and more reliable services, has highlighted the limitations of conventional channel modeling techniques. Factors such as atmospheric conditions, orbital dynamics, and interference from various sources can significantly impact signal quality and system performance. Static models may not account for these variables effectively, potentially leading to suboptimal system designs or unexpected performance issues in real-world deployments.

Furthermore, the testing and validation of satellite communication systems often involve extensive laboratory simulations and field trials. These processes can be time-consuming and resource-intensive, particularly when relying on manual adjustments to channel models and test parameters. The ability to adapt channel models in real-time based on actual performance data could greatly enhance the efficiency and accuracy of testing procedures.

### SUMMARY

According to an aspect of the inventive concepts, a system for adaptive channel model testing in satellite communications is provided. The system includes a channel emulator configured to simulate channel conditions, multiple receivers configured to process signals from the channel emulator, result extractor modules configured to collect performance data from the receivers, a model refinement module configured to analyze the performance data and identify adjustments for channel models, and a channel modification module configured to update the channel emulator settings based on the identified adjustments, thereby forming a feedback loop for continuous adaptation of channel models.

The result extractor modules may be configured to collect performance data including error rates, signal quality, and key performance indicators (KPIs) from the receivers.

The model refinement module may include a MATLAB-based analysis engine configured to calculate refined channel model parameters based on the collected performance data. The refined channel model parameters may include signal loss, delays, and frequency shifts.

The system may further include a user interface configured to display a preliminary channel model for user review and intervention before uploading to the channel emulator.

The channel modification module may be configured to compile the refined channel model parameters into a channel model file compatible with the channel emulator. The channel modification module may be further configured to automatically load and run the compiled channel model file on the channel emulator using Standard Commands for Programmable Instruments (SCPI) or Eggplant SenseTalk scripts.

According to another aspect of the inventive concepts, a method for adaptive channel model testing in satellite communications is provided. The method includes simulating channel conditions using a channel emulator, processing signals from the channel emulator using multiple receivers, collecting performance data from the receivers using result extractor modules, analyzing the performance data and identifying adjustments for channel models using a model refinement module, and updating the channel emulator settings based on the identified adjustments using a channel modification module, thereby forming a feedback loop for continuous adaptation of channel models.

Collecting performance data may include gathering error rates, signal quality, and key performance indicators (KPIs) from the receivers.

Analyzing the performance data may include using a MATLAB-based analysis engine to calculate refined channel model parameters. The refined channel model parameters may include signal loss, delays, and frequency shifts.

The method may further include displaying a preliminary channel model for user review and intervention before updating the channel emulator settings.

Updating the channel emulator settings may include compiling the refined channel model parameters into a channel model file compatible with the channel emulator. The method may further include automatically loading and running the compiled channel model file on the channel emulator using Standard Commands for Programmable Instruments (SCPI) or Eggplant SenseTalk scripts.

According to yet another aspect of the inventive concepts, a non-transitory computer-readable medium is provided storing instructions that, when executed by a processor, cause the processor to perform operations for adaptive channel model testing in satellite communications. The operations include controlling a channel emulator to simulate channel conditions, receiving performance data from multiple receivers processing signals from the channel emulator, analyzing the performance data to identify adjustments for channel models, and updating the channel emulator settings based on the identified adjustments, thereby implementing a feedback loop for continuous adaptation of channel models.

Receiving performance data may include collecting error rates, signal quality, and key performance indicators (KPIs) from the multiple receivers.

Analyzing the performance data may include using a MATLAB-based analysis engine to calculate refined channel model parameters. The refined channel model parameters may include signal loss, delays, and frequency shifts.

The operations may further include displaying a preliminary channel model for user review and intervention before updating the channel emulator settings. Updating the channel emulator settings may include compiling the refined channel model parameters into a channel model file compatible with the channel emulator and automatically loading and running the compiled channel model file on the channel emulator using Standard Commands for Programmable Instruments (SCPI) or Eggplant SenseTalk scripts.

### BRIEF DESCRIPTION OF DRAWINGS

The above and other aspects and features of the inventive concepts will become readily apparent from the detailed description that follows, with reference to the accompanying drawings, in which:

FIG. 1 illustrates a block diagram of an adaptive channel model testing system for satellite communications according to embodiments of the inventive concepts;

FIG. 2 illustrates a block diagram of a system for extracting and processing receiver data in a communication system according to embodiments of the inventive concepts;

FIG. 3 illustrates an example of a display showing network speed tests results;

FIG. 4 illustrates an example of a user interface of a vector signal analyzer (VSA) software displaying an OFDM Error Summary;

FIG. 5 illustrates an example of a command-line interface for fetching and displaying network metrics in a mobile communication system;

FIG. 6 illustrates an example of a debug information display for a cellular communication system;

FIG. 7 illustrates an example of a channel quality vector display for a wireless communication system;

FIG. 8 illustrates a block diagram of a model refinement system for channel adaptation in communication systems according to embodiments of the inventive concepts;

FIG. 9 illustrates a system diagram for channel model adaptation in a test automation environment according to embodiments of the inventive concepts;

FIG. 10 illustrates an example text-based representation of a Prosim® channel model rile;

FIG. 11 illustrates a code snippet for channel model adaptation in a satellite communication testing system according to embodiments of the inventive concepts;

FIG. 12 illustrates a system diagram for channel modification and upload in a communication testing environment according to embodiments of the inventive concepts;

FIG. 13 illustrates a user interface for a channel model viewer according to embodiments of the inventive concepts;

FIG. 14 illustrates a console output of a channel model compilation process for a wireless communication system according to embodiments of the inventive concepts;

FIG. 15 illustrates a user interface for a channel emulation system according to embodiments of the inventive concepts;

FIG. 16 illustrates a system diagram of an automated test environment for channel model adaptation in satellite communications according to embodiments of the inventive concepts; and

FIG. 17 illustrates a detailed test plan according to embodiments of the inventive concepts.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted to avoid obscuring the description of the example embodiments. Such methods and apparatuses are clearly within the scope of the present teachings. Further, throughout the drawings, like reference numbers refer to the same or similar elements.

The terminology used herein is for purposes of describing particular embodiments only, and is not intended to be limiting. The defined terms are in addition to the technical and scientific meanings of the defined terms as commonly understood and accepted in the technical field of the present teachings. As used in the specification and appended claims, the terms ‘a’, ‘an’ and ‘the’ include both singular and plural referents, unless the context clearly dictates otherwise. Thus, for example, ‘a device’ includes one device and plural devices. Further, for example, when one element is described as being “connected to” another element, the one element may be directly connected to the other element, or indirectly connected to the other element in an operative manner.

Separately, as is traditional in the field of the inventive concepts, example embodiments may be described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, in the absence of an indication to the contrary, the units and/or modules being implemented by microprocessors or similar may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the example embodiments. Conversely, the blocks, units and/or modules of the example embodiments may be physically combined into more complex blocks, units and/or modules without departing from the scope of the example embodiments.

The inventive concepts relate to adaptive channel model testing systems and methods for satellite communications. In the current state of the industry, engineers manually change channel models during satellite communication testing, relying on their expertise to adjust parameters and diagnose issues based on observed performance. There is usually no automated feedback mechanism; instead, engineers manually take measurements, identify errors on the receiver side, and make necessary adjustments without direct correlation to specific channel parameters. Impairments cannot always be directly added, particularly when there is no control over the transmitted signal, necessitating the use of channel emulators like Propsim® offered by Keysight® Technologies, Inc. Calibration and throughput normalization are performed using third-party tools, and mobile parameters such as Doppler shifts and fading characteristics are calculated externally. This process is becoming more complex when managing multiple channels, as engineers must track numerous parameters and their impact on system performance manually.

The inventive concepts aim to enhance satellite communication testing by implementing a real-time feedback loop from the diverse device under test (DUT) or by directly measuring receivers' performance. This feedback mechanism facilitates the automatic switching of channel models or adjustment of their parameters based on desired end-to-end key performance indicators (KPIs). Utilizing simulated waveform impairments or the Propsim® channel emulator, the framework also incorporates VSA integration and model parameters readings to generate recalculated channel models. This approach addresses the limitations of static and manually updated emulation environments by providing a dynamic, adaptive system that improves testing accuracy and efficiency in satellite communication.

As will become apparent in the description that follows, the embodiments herein offer a number of advantages such as one or more or all of those enumerated below:
1. Automated Channel Model Adjustments: Streamlines the testing process by automatically adjusting channel models based on receiver feedback.
2. Integrated Feedback Mechanisms: Utilizes end-to-end KPIs to provide automated, continuous feedback for optimizing channel performance.
3. Seamless Integration with VSA: Utilizes Vector Signal Analyzer data such as EVM, frequency, and IQ demodulation metrics to refine channel models.
4. Enhanced User Control via API: Provides user interaction through APIs and tools like Eggplant for comprehensive test management and automation.
5. Unified Testing Framework: Integrates signal generators, receivers, and channel emulators within a cohesive TAP-based framework, simplifying the testing workflow.
6. Versatile Application: Applicable to various communication scenarios, including mobile communications, enhancing flexibility and applicability.
7. Unified Calibration and Normalization: Consolidates calibration and normalization processes within a single framework, reducing the need for separate applications and methodologies.
8. Simplified Impairments Control: Offers straightforward, automated control of impairments.
9. Efficient Multi-Channel Management: Provides mechanisms for effectively managing and updating multiple channels, reducing complexity and improving test consistency.
10. Elimination of Third-Party Tools: Integrates parameter calculations into the main workflow, minimizing reliance on third-party tools and interventions.
11. Cross-Vendor Integration: Supports seamless integration with various signal generators, analyzers, and DUTs, facilitating comprehensive and versatile testing environments.

The framework of the inventive concepts may be implemented using a PathWave® Test Automation KS8400B toolset (offered by Keysight® Technologies) to replicate all the main workflows stages and steps within one environment. The PathWave® toolset, which leverages the OpenTap® open source test automation sequencing engine, allows for a streamlined and efficient process of optimizing test sequences in automated test instruments. Further, an Eggplant® application testing tools are utilized in some embodiments. Unlike traditional application testing tool that taps into the app's user interface framework, the Eggplant® testing tool uses image analysis technology to perform testing tasks and validate functionality based on the app user's perspective. While the embodiments herein are described using these exemplary toolsets, the inventive concepts are not limited thereto.

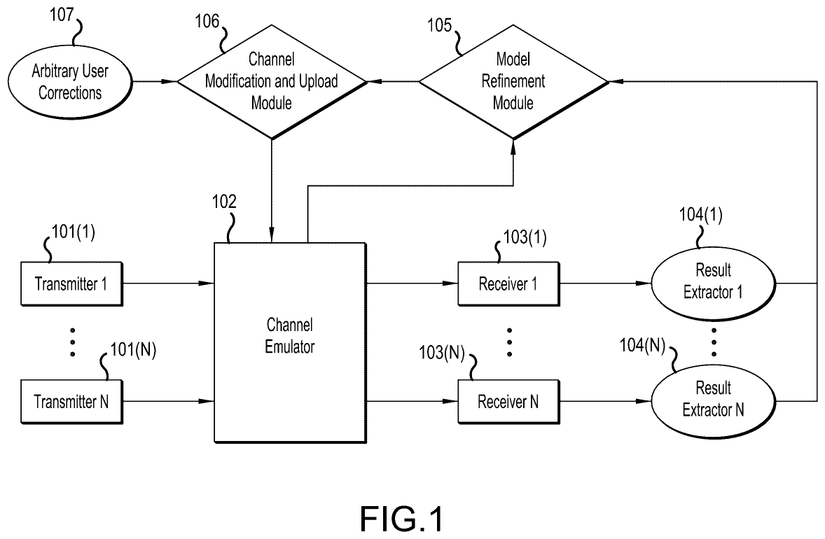

FIG. 1 illustrates a block diagram of an adaptive channel model testing system for satellite communications according to embodiments of the inventive concepts. As will be explained below, the inventive concepts present a main feedback-controlled model adaptation scenario involving a dynamic interaction between multiple transmitters, a channel emulator, and multiple receivers. This setup is designed to optimize the performance of transmission systems by automatically adjusting channel models and their parameters based on real-time feedback from the receivers.

Referring to FIG. 1, an adaptive channel model testing system for satellite communications of the current embodiment includes multiple transmitters 101(1) to 101(N), a channel emulator 102, multiple receivers 103(1) to 103(N), multiple result extractor modules 104(1) to 104(N), a model refinement module 105, and a channel modification and upload module 106. N is an integer of 2 or more.

The transmitters 101(1) to 101(N) send signals to the channel emulator 102. These transmitters, which may be satellite transmitters, represent various signal sources that need to be tested and analyzed. In the most general case transmitter signals cannot be changed.

The channel emulator 102 receives the signals from the transmitters and simulates the channel conditions, such as signal attenuation, multipath fading, or Doppler shifts. This emulator can introduce various impairments and conditions to test the robustness and performance of the receivers. An example of the channel emulator is Propsim® mentioned earlier.

The simulated signals (i.e., the transmitter signal subjected to the simulated channel conditions) are then received by the receivers 103(1) to 103(N). Each receiver processes the incoming signals and acts based on the specific channel properties, which results in specific performance degradation and related error data.

The extracted signal performance quality from each receiver 103 is collected by the result extractor modules 104(1) to 104(N). These modules gather detailed performance data, such as error rates, signal quality, and other relevant KPIs. The output data format is an internal channel description vector. The result extractor modules 104(1) to 104(N) may be implemented in software.

The performance data collected by the result extractors 104 is fed into the model refinement module 105. This module 105 analyzes the data and identifies necessary adjustments to create the new channel models ensuring needed receiver performance. The calculations are done using retrieved channel model parameters from the channel emulator 102. The final product module 105 is the channel emulator-specific data model, later to be used by channel emulator interface/applications. Model refinement module 105 may be implemented in software.

The refined model parameters obtained by the model refinement module 105 are then sent to the channel modification module 106. This module 106 updates the channel emulator 102 settings to reflect the new, optimized parameters. The channel modification module 106 also allows for arbitrary user corrections 107 to be incorporated into the process, ensuring flexibility and adaptability. The channel modification module may be implemented in software.

The entire process represented by FIG. 1 forms a feedback loop where the channel emulator 102 continuously adapts and improves based on real-time feedback from the receivers 103. The loop ensures that the system remains responsive to changing conditions and maintains optimal performance. Details of the results extractors 104(1) to 104(N), the model refinement module 105 and the channel modification and upload module 106 are described herein below.

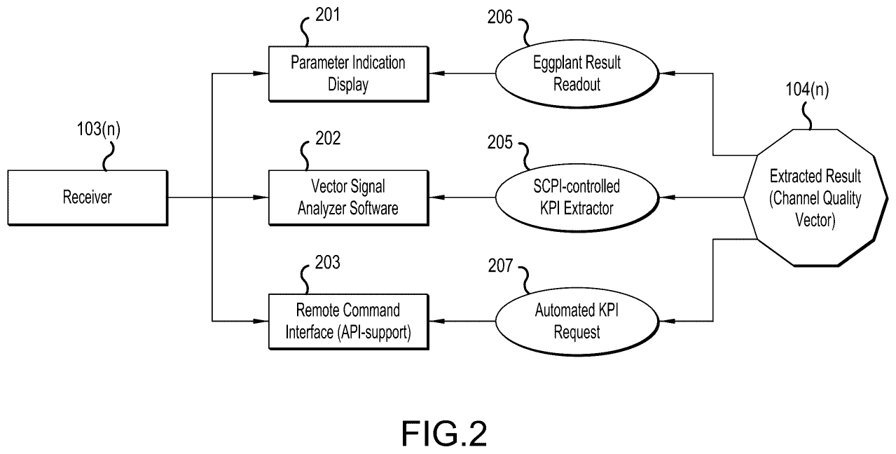

FIG. 2 is a diagram for reference in describing the extraction of valid results from the receivers 103(1) to 103(N) by the result extractors 104(1) to 104(N).

Referring to FIG. 2, receiver 103(n) processes the incoming signals and generates performance data that needs to be analyzed. The type of KPI measurement application or performance indicator depends on a particular receiver type. In the example of FIG. 2, outputs of the receiver 103(n) are applied to a parameter indication display 201, vector signal analyzer software 202 and a remote command interface (API-support) 203.

The parameter indication display 201 displays real-time performance parameters. It receives data from the receiver 103(n) and provides visual feedback to the user through an Eggplant result readout.

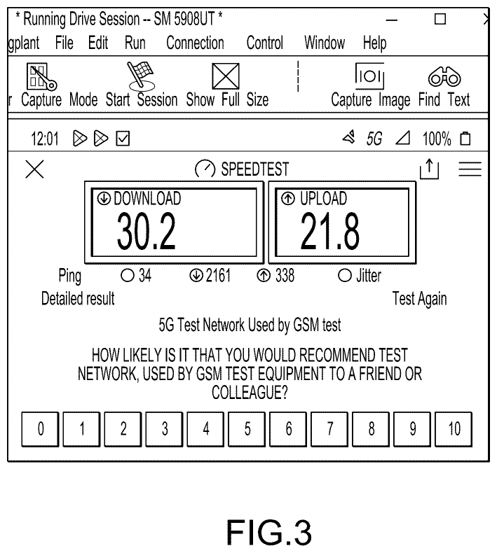

The Eggplant® Result Readout 206 of FIG. 2 is a tool the captures the performance metrics displayed by the Parameter Indication Display 201 whereas Eggplant® SenseTalk Script is running through a display mirroring gateway. An Eggplant® Analysis Module ensures that the extracted data is accurate and formatted correctly for further processing. FIG. 3 illustrates an example of a SpeedTest network test result displayed on a mobile phone screen. In this example, the Eggplant® toolset is configured to capture the download and upload speeds through image analysis of the mobile phone screen.

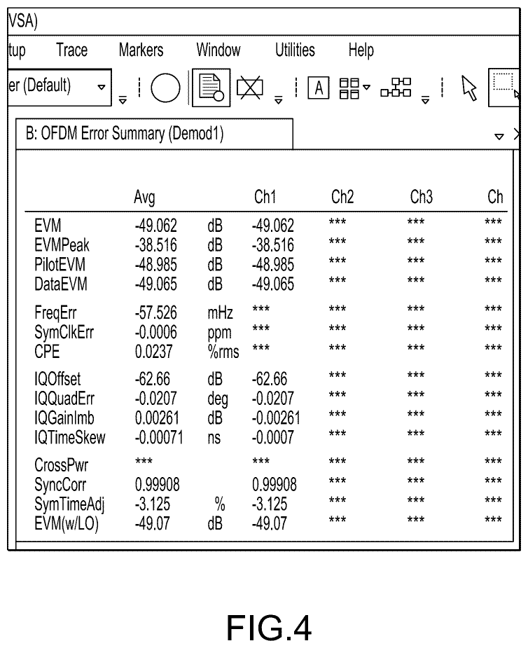

In the example of FIG. 2, the receiver 103(n) sends the processed signal data to the vector signal analyzer (VSA) software using low-level hardware drivers available for the test instruments, for example Keysight® Test Instruments. This software performs in-depth analysis of the signal, extracting key performance indicators (KPIs) such as EVM, frequency, and IQ demodulation metrics. An example of this is shown in FIG. 4, KPI average values are displayed for a given receiver channel (Ch1).

Still referring to FIG. 2, the VSA software 202 communicates with an SCPI-controlled KPI extractor 205. The SCPI-controlled KPI extractor 205 automates the extraction of the performance metrics (such as those shown in FIG. 4) using Standard Commands for Programmable Instruments (SCPI) and a test automation plugin.

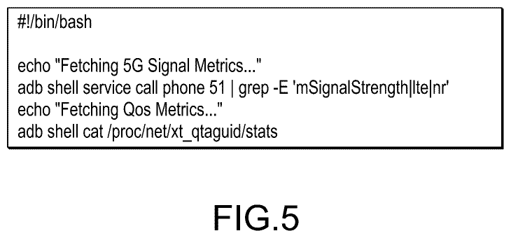

The receiver 130(n) in the example of FIG. 2 also interfaces with a remote command system via API support 203. This system handles automated requests for specific KPIs and other performance data retrieval. In this case specific parameters might be requested within a testing sequence by separate commands, for example, in ADB-interface as shown in the example of FIG. 5.

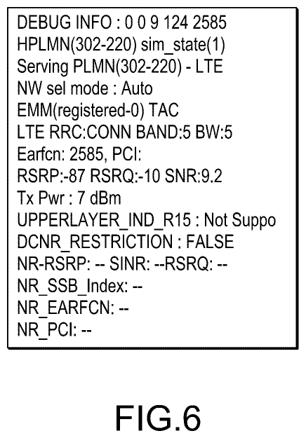

An automated KPI request module 207 sends automated requests to the receiver through the remote command interface 203, ensuring that all necessary performance metrics are collected systematically. An example of such a KPI report response from a cellular modem is shown in FIG. 6. It can be seen that the report response contains several RF metrics such as RSRP, SNR, Tx Pwr, and so on.

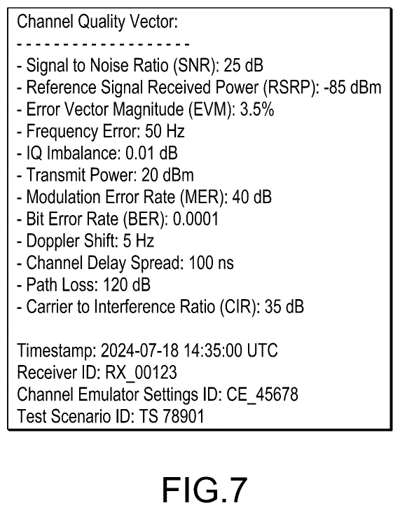

Extracted Result 104(n) for the receiver 103(n) are compiled. That is, all extracted performance data, including channel quality vectors, are compiled. This consolidated data provides a comprehensive view of the receiver's performance within provided channel characteristics. An example of a channel quality vector is illustrated in FIG. 7.

The integration of the components of FIG. 2 allows for efficient and accurate extraction of performance data from heterogenous receivers, ensuring that the feedback loop for channel model adaptation is based on precise and real-time metrics.

The model refinement module 105 of FIG. 1 will now be described in more detail.

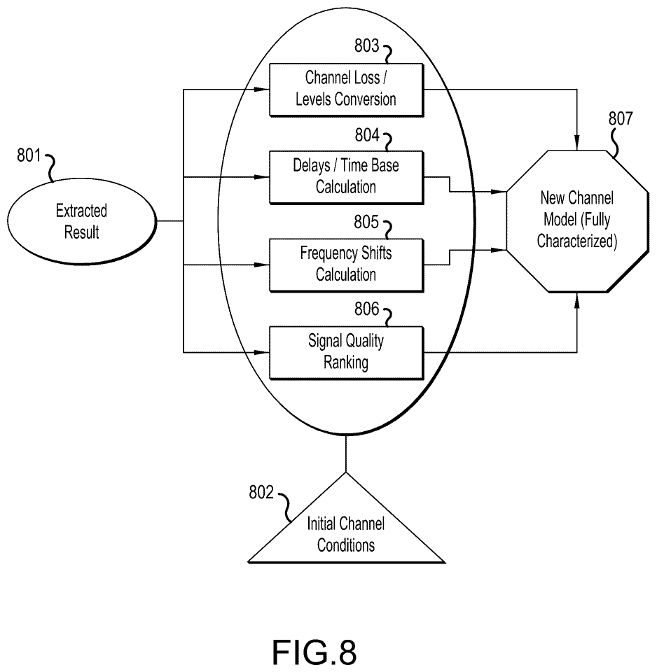

The model refinement process aims to create a fully characterized new channel model based on the extracted results from the receiver 103(n) and the initial channel conditions retrieved from channel emulator 102. This process involves several key components and calculations to ensure the channel model changes are aligned with the testing goals, such as reaching the maximum throughput, desired EVM values or the most extreme sustainable channel conditions. The steps involved are describe next with reference to FIG. 8.

FIG. 8 illustrates a diagram for reference in describing a model refinement model refinement model 105 according to embodiments of the inventive concepts.

The process begins with the input of extracted results 801 from the receiver 103(n) by the result extractor 104(n) in the form of a channel quality vector (e.g., see FIG. 7 discussed above), which includes various performance metrics and KPIs. Those are usually absolute values not relative to the channel properties controlled and changed within the channel emulator block.

The initial conditions 802 of the channel, as defined prior to the test completion in the channel emulator interface, provide the baseline parameters against which new measurements are compared. These parameters are retrieved by either making a SCPI or an API call through the Test Automation environment to the channel emulator IO ports. They may include measured transmitter Power, emulated path loss, added Doppler shift/time delay, applied multipath parameters, added noise levels/bandwidth, and so on.

Still referring to FIG. 8, the channel loss/levels conversion module 803 converts the measured receiver power to appropriate signal losses and levels into a format suitable for the channel model. It adjusts the power levels to accurately represent the signal attenuation observed in the lab environment. When the channel emulator is set into “bypass” or “through” mode this module is allowing the normalization as it can calculate the system losses and store them as corrections.

The delays and time base calculation module 804 of FIG. 8 processes the timing information from the extracted channel vector results. It calculates the delays and time offsets based on the known time base parameters from the channel emulator.

The frequency shifts calculation module 805 calculates any frequency shifts observed in the received signal. It accounts for Doppler shifts and other frequency variations to ensure the channel model reflects these dynamics. It can either rely or on the doppler shift retrieved from the initial channel model properties or adjust it based on the VSA Frequency Error reading.

The signal quality ranking module 806 evaluates the overall signal quality relevant to the particular receiver front-end based on the extracted performance metrics from channel quality vectors. It ranks the quality of the signal against the initial KPI levels and limits determined by the user, which also helps to rank the channel model for the desired signal type and receiver.

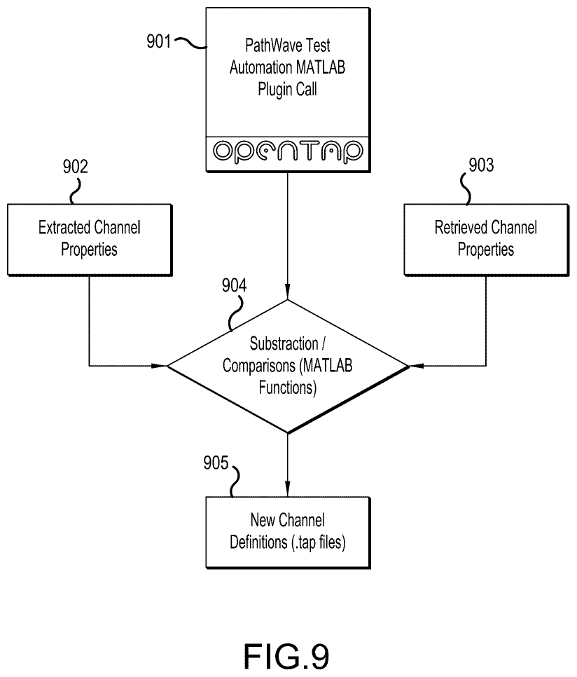

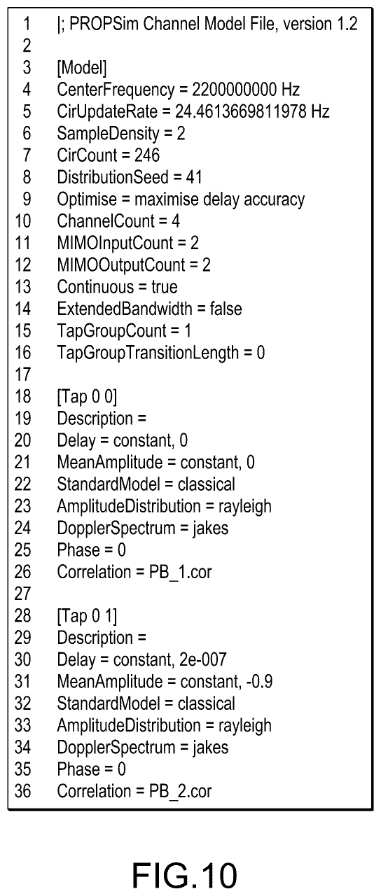

The outputs from the modules 803 through 806 are received by the new channel model (fully characterized) 807 represented in FIG. 8. There, the outputs are combined to create a new, fully characterized channel model. In the case of Propsim® this output file form is . tap format. Referring to FIG. 9, it can be created running existing MATLAB scripts 904 within the Test Automation environment allowed by an installed MATLAB plugin 901. The scripts 904 process the extracted channel properties 902 and the retrieved channel properties to obtain the new channel properties 905 as described above. An example of a . tap file is shown in FIG. 10.

MATLAB plays a role in the framework of the inventive concepts by providing a robust platform for complex mathematical calculations, data analysis, and model generation. MATLAB is particularly effective for handling the following tasks within this solution:
1. Data Extraction and Analysis: MATLAB is used to process and analyze the extracted channel quality vectors, providing insights into signal performance metrics such as SNR, RSRP, EVM, and more.
2. Model Refinement and Parameter Calculation: MATLAB is employed to refine channel models based on the performance data, calculating key parameters such as signal loss, time delays, frequency shifts, and signal quality rankings.
3. Automated Model Generation: MATLAB scripts are used to automate the creation of new channel models, translating the refined parameters into a format compatible with the channel emulator (e.g., TAP files for Propsim).
4. Integration with Test Automation: MATLAB integrates seamlessly with the PathWave Test Automation environment, enabling automated testing and model adjustments through MATLAB functions and plugins.

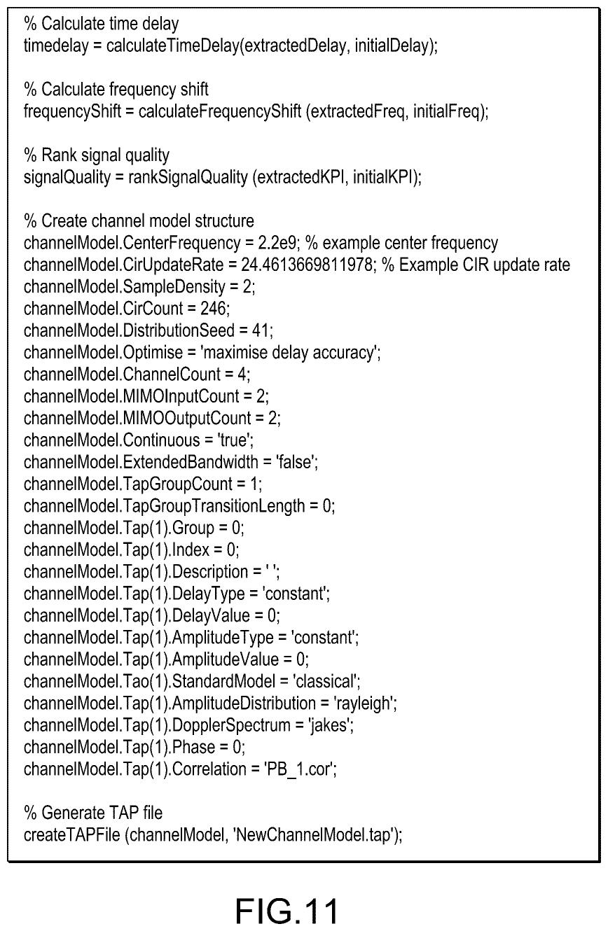

FIG. 11 illustrates an example code which run by the MATLAB engine as a test step property in OpenTAP®.

The channel modification and upload module 106 of FIG. 1 will now be described in detail.

The channel Modification and Upload Module is designed to refine and upload channel models (in non-encrypted text-formatted .tap-files) to the Propsim® emulator based on user intervention and refined parameters.

FIG. 11 illustrates a diagram for reference in describing a model refinement model refinement model 105 according to embodiments of the inventive concepts.

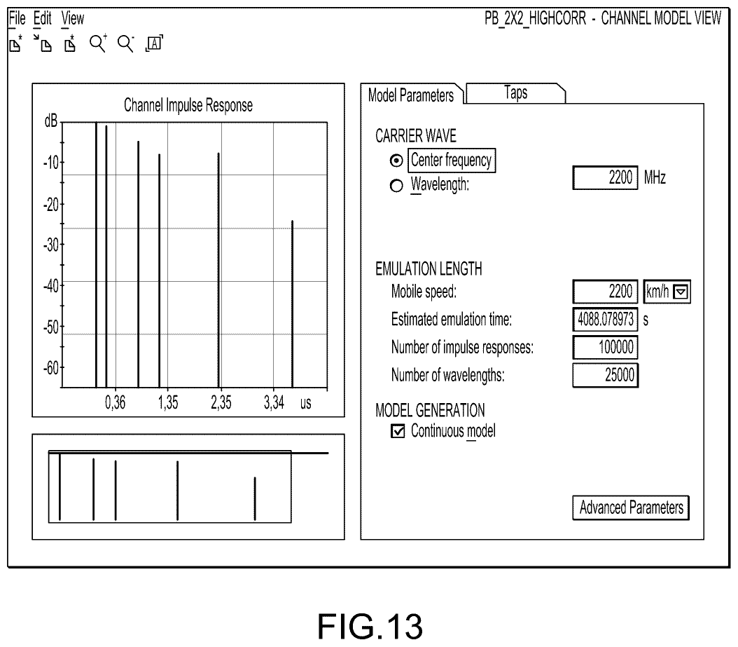

Refined model parameters 1201(1) through 1201(N) are input for each of the receivers 101(1) through 101(N). These parameters were derived from the extracted channel quality vectors, further refined through MATLAB calculations as described above. As shown in the example of FIG. 13, the parameter can be displayed in the Propsim® interface in an Editing mode.

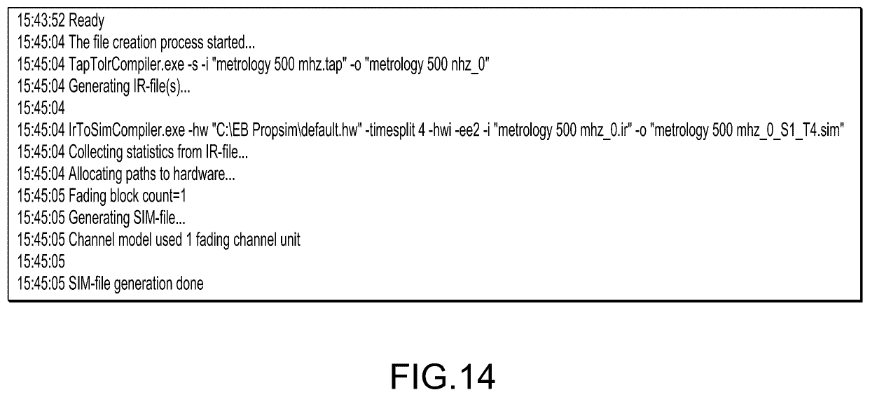

The channel emulator application and model compiler 1202 compiles the refined model parameters into format suitable for the channel emulation. In embodiments, this involves creating a . sim file that includes all necessary channel characteristics and conditions which is done using an internal channel emulator procedure such as that shown in FIG. 14.

Through use of the modeling application selection module, the user can select the appropriate modeling application based on the requirements and conditions of the test. This step involves choosing the right application and an appropriate communication protocol (e.g., SCPI for standard models and Eggplant® SenseTalk for spatial and MIMO-models with Geometry Channel Modelling (GCM) Tool).

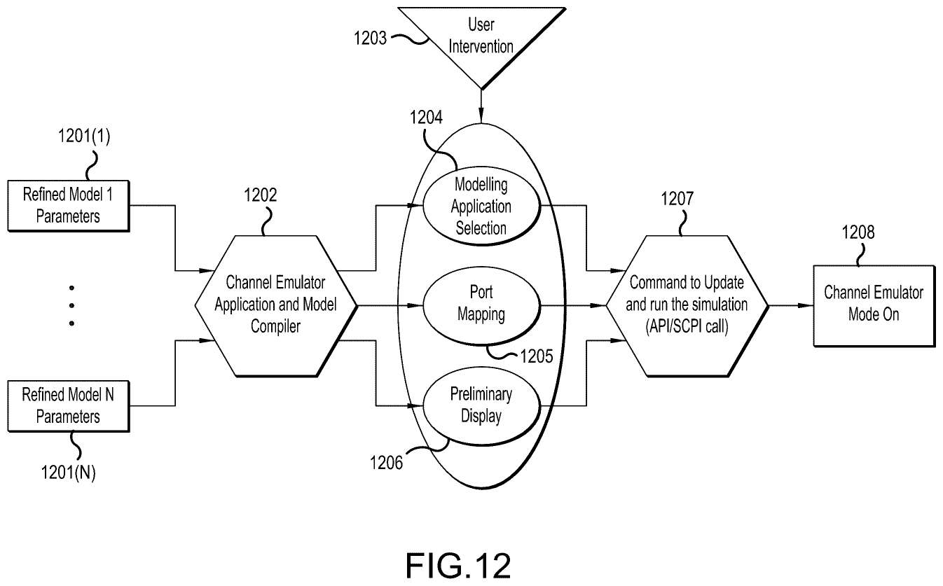

Still referring to FIG. 12, the port mapping module handles the allocation of input and output ports for the channel emulator. This step ensures that the channel model is correctly mapped to the physical ports on the emulator, allowing for accurate signal transmission and reception.

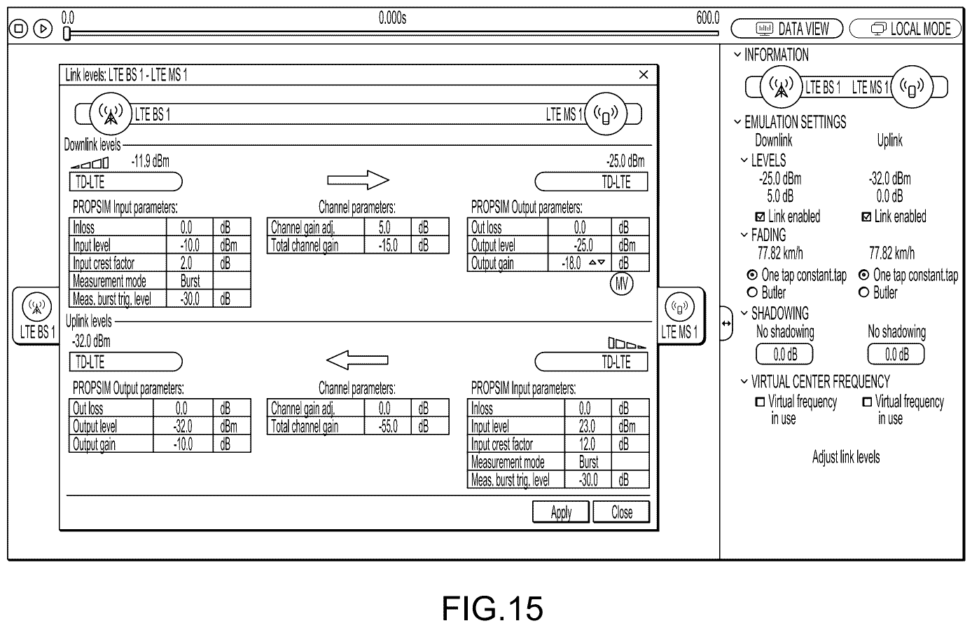

Before finalizing the channel model, a preliminary display 1206 is shown to the user. This display, such as that shown in FIG. 15, includes all the key parameters and settings of the model, allowing the user to review and make any necessary adjustments. As shown in FIG. 15, the display 1206 may include input and output parameters for both the downlink and uplink. These parameters may include input level, output level, and various gains. In some cases, the system may allow for adjustment of channel gain and total channel gain. Measurement modes and noise floor levels may also be configurable. On the right side of the interface, additional settings may be available. These may include emulation settings, level adjustments, and fading options. In some implementations, the interface may provide controls for adjusting link speeds and enabling or disabling shadowing effects. The bottom of the interface may contain buttons for applying changes or closing the configuration window. This layout may allow users to view, verify and/or modify multiple aspects of the channel emulation simultaneously.

The user intervention 1203 illustrated in FIG. 12 refers to a process in which the user can intervene to accept or further refine the channel model. This step ensures that the user has full control over the final model that will be uploaded to the emulator.

Automated model loading and running occurs next. Once the user approves the model, an aggregated Eggplant Script or SCPI call 1207 is generated. This call includes all the necessary commands to update the channel model 1208 in the emulator interface and start running.

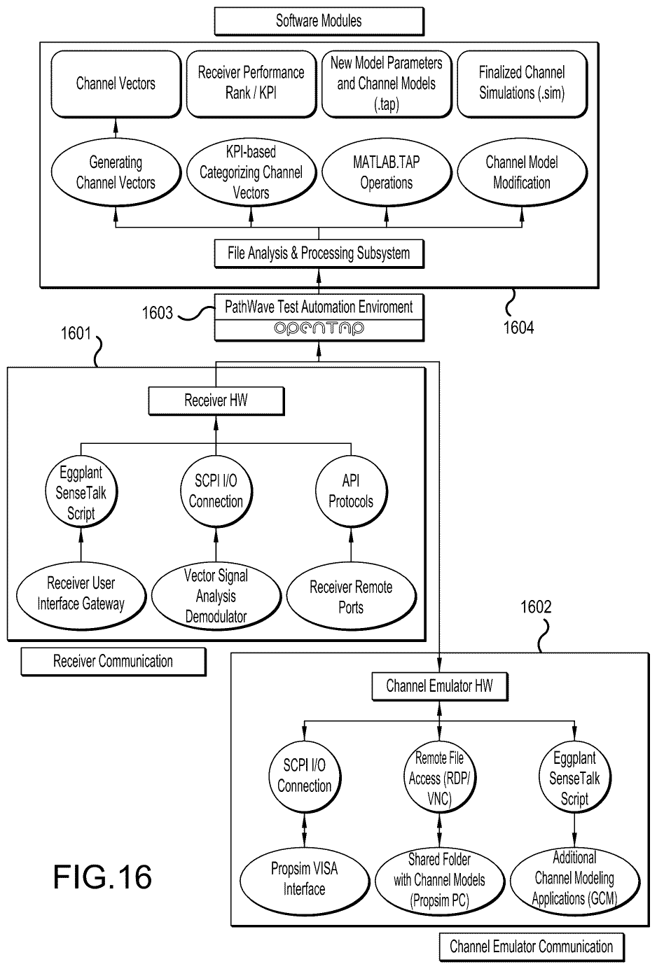

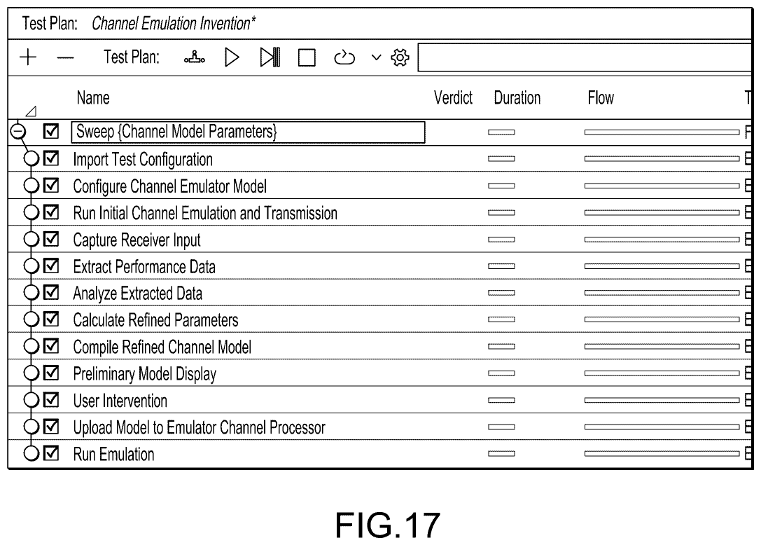

Described next is a practical implementation of the inventive concepts within the PathWave® test automation environment. As suggested previously, the workflow may run within a single PathWave® test automation environment. FIG. 16 illustrates the automation architecture and hardware/software communication mechanism in this case, and FIG. 17 is an example Test Automation Structure that reflects the workflow operations. In FIG. 16, reference number 1601 is a block for relating receiver communication, reference number 1602 is a block relating to channel emulator communication, reference number 1604 is a block relating to software modules, and reference number 1603 denotes the PathWave® test automation environment with the OpenTap® interface.

Referring collectively to FIGS. 16 and 17, a description of the test plan steps of FIG. 16 is enumerated below.
1. Import Test Configuration
   Description: Load the initial test configuration and setup parameters.
   Function: Ensure the Channel Emulator remote interface and correct port mapping configuration is turned on.
2. Configure Channel Emulator Model
   Description: Set up the channel emulator with initial channel conditions and impairments.
   Function: Validate the . sim-model is present and uploaded, and ensure the receiver ports'power meters are measuring the correct power from transmitters.
3. Run Initial Channel Emulation and Transmission
   Description: Transmit signals from the initialized transmitters through the channel emulator.
   Function: Toggle the simulation mode on and confirm output ports are transmitting power.
4. Capture Receiver Input
   Description: Capture the input signals received by multiple receivers.
   Function: Collect performance data from various receivers (the receiver type is defined by the user, which also determines the communication protocol to be used).
5. Extract Performance Data
   Description: Use result extractor modules to gather detailed performance data.
   Function: Extract error rates, signal quality, and other relevant KPIs.
6. Analyze Extracted Data
   Description: Analyze the extracted performance data to identify necessary adjustments.
   Function: Feed the performance data into the model refinement module and rank the receiver performance based on KPI analysis.
7. Calculate Refined Parameters
   Description: Use MATLAB to calculate refined channel model parameters based on extracted data and test goals.
   Function: Generate parameters such as signal loss, delays, frequency shifts. Adjust model parameters based on the testing targets (e.g., finding receiver performance degradation, optimizing performance and model parameters for certain KPIs, characterizing different channels by ranking them).
8. Compile Refined Channel Model
   Description: Compile the refined parameters into a channel model file (.sim).
   Function: Use Propsim standard tools to create a new, optimized channel model.
9. Preliminary Model Display
   Description: Display the preliminary channel model for user review.
   Function: Download and validate the new . sim-file model to the Propsim interface and wait for the user's response.
10.User Intervention
   Description: Allow the user to accept or further refine the channel model.
   Function: Ensure user control over the final model.
11.Upload Model to Emulator Channel Processor
   Description: Load the compiled channel model into the Propsim® emulator.
   Function: Compile the channel impulse response after selecting this action in the Propsim® standard interface (via SCPI command) or execute it using Eggplant® SenseTalk Script in the Channel Geometry Modelling Tool (GCM).
12.Run Emulation
   Description: Execute the test plan and run the emulation with the new channel model.
   Function: Monitor performance and collect results.
13.Feedback Loop Integration—Sweep Channel Parameters
   Description: Integrate feedback from the emulation to adjust and refine the channel model continuously.
   Function: Ensure continuous optimization based on real-time data.

The inventive concepts encompass systems and methods for real-time channel model adaptation based on receiver feedback and performance metrics as described above. Further, the inventive concepts encompass non-transitory computer readable storage media having instructions stored therein that when executed by a processor cause the processor to carry out the methods of the inventive concepts. The memory storing the instructions can comprise random access memory (RAM), read only memory (ROM), optical read/write memory, cache memory, magnetic read/write memory, flash memory, and/or any other non-transitory computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. While representative embodiments are disclosed herein, one of ordinary skill in the art will appreciate that many variations that are in accordance with the present teachings are possible and remain within the scope of the appended claim set. The invention therefore is not to be restricted except within the scope of the appended claims.

What is claimed is:

1. A system for adaptive channel model testing in satellite communications, comprising:
a channel emulator configured to simulate channel conditions;
multiple receivers configured to process signals from the channel emulator;
result extractor modules configured to collect performance data from the receivers;
a model refinement module configured to analyze the performance data and identify adjustments for channel models; and
a channel modification module configured to update the channel emulator settings based on the identified adjustments, thereby forming a feedback loop for continuous adaptation of channel models.

2. The system of claim 1, wherein the result extractor modules are configured to collect performance data including error rates, signal quality, and key performance indicators (KPIs) from the receivers.

3. The system of claim 1, wherein the model refinement module comprises a MATLAB-based analysis engine configured to calculate refined channel model parameters based on the collected performance data.

4. The system of claim 3, wherein the refined channel model parameters include signal loss, delays, and frequency shifts.

5. The system of claim 1, further comprising a user interface configured to display a preliminary channel model for user review and intervention before uploading to the channel emulator.

6. The system of claim 1, wherein the channel modification module is configured to compile the refined channel model parameters into a channel model file compatible with the channel emulator.

7. The system of claim 6, wherein the channel modification module is further configured to automatically load and run the compiled channel model file on the channel emulator using Standard Commands for Programmable Instruments (SCPI) or Eggplant SenseTalk scripts.

8. A method for adaptive channel model testing in satellite communications, comprising:
simulating channel conditions using a channel emulator;
processing signals from the channel emulator using multiple receivers;
collecting performance data from the receivers using result extractor modules;
analyzing the performance data and identifying adjustments for channel models using a model refinement module; and
updating the channel emulator settings based on the identified adjustments using a channel modification module, thereby forming a feedback loop for continuous adaptation of channel models.

9. The method of claim 8, wherein collecting performance data comprises gathering error rates, signal quality, and key performance indicators (KPIs) from the receivers.

10. The method of claim 8, wherein analyzing the performance data comprises using a MATLAB-based analysis engine to calculate refined channel model parameters.

11. The method of claim 10, wherein the refined channel model parameters include signal loss, delays, and frequency shifts.

12. The method of claim 8, further comprising displaying a preliminary channel model for user review and intervention before updating the channel emulator settings.

13. The method of claim 8, wherein updating the channel emulator settings comprises compiling the refined channel model parameters into a channel model file compatible with the channel emulator.

14. The method of claim 13, further comprising automatically loading and running the compiled channel model file on the channel emulator using Standard Commands for Programmable Instruments (SCPI) or Eggplant SenseTalk scripts.

15. A non-transitory computer-readable medium storing instructions that, when executed by a processor, cause the processor to perform operations for adaptive channel model testing in satellite communications, the operations comprising:
controlling a channel emulator to simulate channel conditions;
receiving performance data from multiple receivers processing signals from the channel emulator;
analyzing the performance data to identify adjustments for channel models; and
updating the channel emulator settings based on the identified adjustments, thereby implementing a feedback loop for continuous adaptation of channel models.

16. The non-transitory computer-readable medium of claim 15, wherein receiving performance data comprises collecting error rates, signal quality, and key performance indicators (KPIs) from the multiple receivers.

17. The non-transitory computer-readable medium of claim 15, wherein analyzing the performance data comprises using a MATLAB-based analysis engine to calculate refined channel model parameters.

18. The non-transitory computer-readable medium of claim 17, wherein the refined channel model parameters include signal loss, delays, and frequency shifts.

19. The non-transitory computer-readable medium of claim 15, the operations further comprising displaying a preliminary channel model for user review and intervention before updating the channel emulator settings.

20. The non-transitory computer-readable medium of claim 19, wherein updating the channel emulator settings comprises compiling the refined channel model parameters into a channel model file compatible with the channel emulator and automatically loading and running the compiled channel model file on the channel emulator using Standard Commands for Programmable Instruments (SCPI) or Eggplant SenseTalk scripts.
